(19) United States
(12) Patent Application Publication
(10) Pub. No.: US 2017/0039637 A1
(43) Pub. Date: Feb. 9, 2017

(54) COMPUTER-IMPLEMENTED METHOD, A SYSTEM AND COMPUTER PROGRAM PRODUCTS FOR ASSESSING THE CREDIT WORTHINESS OF A USER

(71) Applicant: TELEFONICA DIGITAL ESPANA, S.L.U., Madrid (ES)

(72) Inventors: Jose San Pedro WANDELMER, Madrid (ES); Davide PROSERPIO, Madrid (IT); Nuria OLIVER RAMIREZ, Madrid (ES); Jaime Gonzalez RODRIGUEZ, Madrid (ES)

(73) Assignee: TELEFONICA DIGITAL ESPANA, S.L.U., Madrid (ES)

(21) Appl. No.: 14/818,583

(22) Filed: Aug. 5, 2015

(51) Int. Cl. G06Q 40/02

(52) U.S. Cl. CPC G06Q 40/025

(57) ABSTRACT

A computer-implemented method, a system and computer programs products for assessing the credit worthiness of a user,

the method comprising: collecting, by a data collector, information about communications conducted by users' of a communication network, the collected information at least comprising Call Detail Records including calls; analyzing, by a computing system, during a specific time frame, the collected information regarding a particular user including communications' started by the particular user and/or communications' received by the user, and determining, data variables from the analyzed information, the data variables including at least communication patterns; and computing, by the computing system, both a default risk score and a fraud risk score of the user by using the determined data variables.

### TECHNICAL FIELD

The present invention is directed, in general, to the field of financial scoring techniques. In particular, the invention relates to methods, systems and computer programs for assessing the credit worthiness of a user.

### BACKGROUND OF THE INVENTION

Financial scoring is mainly based on the use of predictive algorithms to determine the likelihood of a user/customer defaulting on a specific financial product. To this end, different sets of data are used to represent the costumer characteristics. One of the most well-known examples are credit scores, which are used to assess loan applications; in this case, the score tries to discriminate between customers with high probability of default (low score) from customers with low probability of default (high score).

Current scoring techniques can be classified according to two main dimensions: the data used to derive the score, and the algorithms used to process that data.

Regarding the data, mainstream current credit scores are calculated upon financial and demographic data, hence making part of the population not easy to score. A second group of scores uses what is called alternative data, meaning data that is not directly financial history but is related to costumers' behavior that correlates with their financial risk. Within these two groups there are also subcategories that could be summarized as follows:

Traditional Scores: financial history and behavior plus selected demographic information are used to derive the credit score:
Bureau (or generic) Scores: These scores are provided by third parties (i.e.: bureaus like Experian™ or specialized technological companies like Fico™) to bank and lenders besides other credit related reporting services. These scores are generally based on data like the credit history, current credit use, relationship between credit limit and outstanding balance, etc. They have the limitation of not considering particular characteristics of some segments of the population and they have very limited value in the case of individuals with no past credit history.
Internal and bespoke scores: Once a costumer has a history on a bank or financial institution, these organizations are able create their own internal scores based on that history, and can also apply this model to new clients. Besides, bureaus and the likes, also adapt their models to a bank's specific characteristics and information, generating what is called a bespoke score. This score is based on financial information collected by the lender and the information that bureaus could collect regarding the lender's costumers. These scores have greater accuracy than generic scores, at the expense of reduced flexibility and higher cost, not only to develop them but also because they need to be recalibrated.

Alternative Scores: These scores are built using non-financial/credit history. They are significantly less spread that the traditional scores, and can be subdivided according to the data sources used:
Utility Data: Utilities payment information (electric, telecom, etc.) by companies is used to derive the scores. The big global bureaus and other companies, mainly North American, (e.g. LexisNexis™) provide this kind of scores. The limitation in this case resides on the data that is available, both in terms of richness and reach, as typically only one or two characteristics are available and availability is mainly restricted to developed economies.
Payment/e-commerce transactions: Payments and related data captured by wholesale suppliers and online merchants are being used to assess the credit worthiness of small businesses and their owners. AliFinance™, which provides loans to small and medium-sized enterprises in China, controls credit risk with payment information harvested from borrowers who are also e-commerce merchants of the Alibaba Group™, the parent company of AliFinance™.
Mobile Data: There are existing solutions mainly based on mobile data from mobile phone users, and focused on communication information. Cignifi™ and First Access are the main examples in this category. They primarily focus on scores to be applied in marketing (Cignifi™) or to assess application (First Access). These scores lack flexibility, the model is costly to recalibrate and in a minor scale the selection of features to calculate the scores is not well defined.
Psychometric Scores: These scores are based on a psychometric profile, which is usually created by means of self-reported questionnaires. VisualDNA™ and Entrepreneurial Finance Lab™ are applying this approach. A big limitation of these scores lies in the way they collect the information (via questionnaires), which limits their scalability.
Social Data: In these case scores are calculated using social-media information (e.g.: Facebook™ news and likes) and other online activity. This is a growing scoring model, and it's mainly used by online microcredit companies (e.g.: Wonga™, Kreditech™, etc.).

As a general consideration, traditional scores have the advantage of transparency: it is relatively simple to explain to a non-savvy person how the score is derived (e.g.: your score is low because of having too many open credit lines almost exhausted). Hence, these scores have been the preferred ones since credit scoring was introduced. Alternative scores have been used to a lesser degree and with varying success.

In terms of the algorithms used to compute credit scores, a number of approaches have been developed since the 1960's when credit scores started to be used in a generalized way. This evolution goes in parallel with the evolution of data analysis and machine learning techniques. Broadly speaking, the approaches to compute scores can be:
Parametric, which make assumptions about the data, being discriminant analysis and, generalized linear models (GLM) the most prominent ones. These methods have been proven to be very powerful but make assumptions about the data that do not always hold true (e.g.: linearity and homoscedasticity in the case of linear discriminant analysis). In addition, they can be computationally costly to train, which becomes a limitation when big data sets need to be considered.
Non-parametric, which do not make any assumptions about the input data and are mainly based on Machine Learning algorithms such as neural networks and related algorithms (ANNs), genetic algorithms, or decision trees. Non-parametric techniques allow to adapt the algorithms to changing environments, which simplifies their adaptation to different uses or their recalibration, for example when the financial and economic context changes. At the same time, they are more easily applicable to data sets where direct relation with financial behavior is not evident (e.g.: mobile data, social data). One of the drawbacks of non-parametric methods is the difficulty interpreting the models and the risk of over-fitting when there isn't enough training data.

Which approach is best for credit scoring strongly depends on data and the context. Logistic regression is probably the most used technique nowadays, such that almost all traditional and event alternative scores use logistic regression today (e.g.: Entrepreneurial Finance Lab™ on psychometrics). The main reasons to use logistic regression are that it is well suited for modelling binary outcomes and the scores can be easily converted into probability estimates. However, note that this approach would not be so well suited for changing environments or big data sets with hundreds of features and characteristics to decide from. In other methodologies, a practical comparison between the different techniques is given showing that for a specific context multiple techniques can achieve similar ranking capabilities.

The state-of-the-art scoring techniques used in the financial sector heavily rely on the presence of past financial information. The segment of the population demanding creditworthiness assessment for which this information is not available is growing as new developing economies start to emerge, although the problem is also prevalent in developed countries. The main groups of thin-files include: unbanked population (the World Banks estimates that there are 2.5 billion individuals worldwide who do not have access to a bank account), underbanked (individuals who have a bank account but do not use it on a regular basis, which only in the UK accounts for eight million people), young graduates and immigrants (only in the U.S.A. there are 1.1 million working immigrants per year, a great majority of them without previous financial history in the U.S.A.).

When no financial data is available, credit scores are less reliable and accurate. Moreover, generic scores require being adapted for specific information and data available only to lenders. Alternatives scores also suffer some limitations, such as lower potential accuracy because of using data with limited depth (e.g.: utilities payments) and high homogeneity (e.g.: psychographic-based scores), limited flexibility and computational cost to adapt them to new environments or to select input parameters (e.g.: mobile data using logistic regression), and difficulties to perform with non-homogeneous data (as in the case of social-based scores, where building the model depends on having accurate information on the identity of the individuals and crossing that identification with financial performance).

This situation creates a double-sided problem. Banks and financial institutions prefer to reduce risks and costs by limiting their offer to (highly) scored customers, which also limits their potential growth. This behavior creates an artificial glass ceiling because credit assessment of individuals unknown to a lender is often subjective, time consuming and expensive, potentially involving home visits by loan officers to interview applicants and their neighbors. Moreover, Credit bureau coverage may be patchy or non-existent, reflective of the fact that many consumers in these markets have little or no history with financial institutions. In such environments, many lenders prefer to focus on cross selling to existing customers or catering to those for whom credit history information is more readily accessible (typically, the more affluent). As a result, a second problem is created because potential customers are shut off from credit: they cannot get access to credit because they cannot be scored; without credit, they cannot generate a financial history to be scorable.

An object of present invention is, therefore, to solve the financial institutions and lenders problems and, in doing so, to improve the situation of all users that do not have access to credit due to lack of traditional credit information.

### DESCRIPTION OF THE INVENTION

To that end, present invention provides a new method for representing a user into a variable space suitable for creditworthiness assessment solely based on Human Dynamics Data (HDD), which doesn't need to use past financial history (It can use it to improve performance of the method). Such representation allows generating reliable credit scores (e.g. a default risk score and a fraud risk score of said user) using for instance machine learning techniques (parametric and non-parametric). Moreover, because it does not use data from the user's financial history, it has the ability to score a wider range of people than traditional methods, while keeping a similar accuracy level

Embodiments of the present invention provide according to a first aspect a computer-implemented method for assessing the credit worthiness of a user, preferably with a limited credit worthiness history. According to the proposed method, a data collector unit (e.g. of a Telecommunication operator) collects information about communications conducted by users' of a communication network and then a computing system (with access to, or having connection to, the data collector) analyzes the collected information, during a specific time frame, regarding a particular user including communications' started by the particular user and/or communications' received by the user, and determines data variables (e.g. communication patterns) from the analyzed information. Finally, the computing system uses the determined data variables to compute both a default risk score and a fraud risk score of the user.

The collected information preferably includes Call Detail Records, e.g. calls. However, in some embodiments of the proposed method the collected information may further include text messages or even network traces/events.

In addition, the collected information may further include data related to a financial behavior of the users' including top-ups or online payments performed in their phone lines. In this case, the proposed method, according to an embodiment, determines data variables about a financial pattern of the particular user, said financial pattern including determining the number of top-ups performed, and/or the monetary amount of the top-ups, and/or the time between top-ups, and/or the number of top-ups with economic value above/below a specific threshold.

The communication patterns may include determining the number and duration of the communications, and/or the type of the communications including voice and/or text, and/or the ratio of the communications actively started by the users versus replied, and/or the ratio of time spent talking by the particular user versus time spent listening and/or a number of participants in the communication.

According to an embodiment, the proposed method further uses a parameter including a maturity period to determine whether the computed risk score is a default risk score or a fraud risk score. In this case, said maturity period uses a given threshold characterizing a time of observation since a financial product is activated by the particular user. Preferably, the given threshold of the maturity period is three months.

Moreover, said parameter may further include a number of days in arrears to consider the particular user in default.

According to an embodiment, the data variables further include location and mobility patterns. The mobility patterns may include determining a distance traveled for the particular user during said specific time frame, and/or the frequency of travelling events, and/or the regularity of the trips in terms of the spatial (geographic location visited) and the temporal dimension (time of the day, day of the week, etc.), and/or a pattern of stationary behavior of the particular user, and/or the velocity to travel between an origin and a destination during a communication. On the other hand, the location patterns may include determining the home and/or work location of the particular user, and/or a value representing the regularity of location in said specific time frame, and/or a location at a pre-define time of interest.

According to another embodiment, the data variables further include social network metrics. In this case, the social network metrics may include determining the number of people with which the particular user has communicated or has received a communication during said specific time frame, and/or the distribution of the communications in time using metrics of dispersion including a daily variance and/or an entropy variable.

According to yet another embodiment, the data variables may further include location and mobility patterns and social network metrics.

According to an embodiment, the invention allows for the parallel modeling of different risk profiles (e.g. default and fraud) for each customer. The multifaceted score enables taking further informed decisions about credit applications depending on the policies of each lender with regards to the different risk profiles.

According to an embodiment, the further computed default risk score and the fraud risk score are displayed (e.g. on a screen of a computing device) in a single two dimensional graph, and the method further performs an assessment of an overall risk parameter of the particular user.

Several financial products for the user may be analyzed by using the computed default risk score and the fraud risk score, the several financial products at least including a credit card credit, a personal loan, a telephone and communication contract, and/or a microcredit.

According to an embodiment, the specific time frame is greater or equal than one week. Preferably, the specific time frame is one month or greater.

According to an embodiment, the information is collected on a daily basis. The information may be further partitioned in the time dimension depending on the time of day (e.g. offices hours/leisure time) or the day of the week (e.g. weekdays/weekends).

Other embodiments of the invention that are disclosed herein also include a system and software programs to perform the method embodiment steps and operations summarized above and disclosed in detail below. More particularly, a computer program product (non-transitory) is one embodiment that has a computer-readable medium including computer program instructions encoded thereon that when executed on at least one processor in a computing system causes the processor to perform the operations indicated herein as embodiments of the invention.

The credit worthiness predictive model may be recalibrated or redefined in an automated fashion and can be used for both real-time demands and for batch processing.

Present invention, when compared to the background art, is flexible and adaptable. The proposed approach offers great flexibility in the selection of the parameters that are important in the inference of creditworthiness without incurring significant penalties in computational costs. Moreover, the proposed approach is very adaptable to changing contexts, including but not limited to changes in the economic situation of a user, a specific country to countries with different financial situations, e.g.: from highly unbanked to highly banked. Finally, the proposed invention allows to easily recalibrating the model in spite of changes in the objectives of the score.

Moreover, present invention provides high accuracy levels when credit and financial information is scarce or unavailable.

In addition, given the almost universal adoption of mobile phones and related technologies, the proposed approach enables to generate a credit score to large portions of the population in a specific geographic region.

The proposed approach collects human behavioral data in a fully automated and transparent way, without requiring explicit introduction of information by the users.

Moreover, given that the data analyzed by the present invention is passively collected by the data collector, for instance of a mobile network infrastructure, its collection for the purposes of this invention requires minimal additional cost.

Finally, regarding traditional score models, the proposed invention overcomes their limitations in accuracy and lack of flexibility, and can complement them by providing an alternative and more flexible option because it considers the analysis of non-traditional widely available variables, i.e. from mobile and telco data. It also overcomes the limitation of accuracy and lack of flexibility of alternative scores by means of their recalibration and remodeling capabilities and the specific use of known machine learning technologies. In this way, present invention provides a better technical accuracy and discrimination capabilities for a wider range of uses and with an improved selection of significant characteristic from used data.

### BRIEF DESCRIPTION OF THE DRAWINGS

The previous and other advantages and features will be more deeply understood from the following detailed description of embodiments, with reference to the attached, which must be considered in an illustrative and non-limiting manner, in which:

FIG. 1 is a flow chart schematically illustrating a method for assessing the credit worthiness of a user according an embodiment.

FIG. 2 is a flow chart schematically illustrating another embodiment of a method for assessing the credit worthiness of a user, in this case by an offline calculation.

FIGS. 3A, 3B and 3C schematically illustrate another embodiment of a method for assessing the credit worthiness of a user. FIG. 3A illustrates the interaction of customers (i.e. users) with Telco and the information collected. FIG. 3B illustrates the interaction of customers with financial products and the information collected. FIG. 3C is a high level view of the proposed method.

### DETAILED DESCRIPTION OF THE INVENTION AND OF SEVERAL EMBODIMENTS

Present invention provides a method and a system to generate a multifactorial representation of a user's personality and behavior characteristics. Such representation can be utilized to assess accurately the user creditworthiness by means of statistical modeling and machine learning techniques.

Said representation comprises a multiplicity of low-level features covering different facets of human traits and behaviors. The overall set of data variables, which are referred as “human dynamics data” (HDD), contains enough information to obtain an accurate profile of behavioral and personality traits of the user, which has been found to correlate well with propensity to financial misbehavior. Hence, it can be used as an input to model creditworthiness.

The proposed HDD-based representation aims at capturing as much information about the user as possible to profile their personality and behavior with enough level of detail to allow for accurate modeling of their creditworthiness.

Present invention considers different data variables related to the following facets of human activity:
Communication patterns, including data variables related to how the user communicates: number and duration of conversations, type of communications (voice, text, etc.), ratio of conversations actively started versus responded, ratio of time spent talking versus time spent listening, number of users/participants in the communication, etc.

It should be apparent to anyone skilled in the art that from this information, concrete data variables can be generated by aggregating specific pieces of information over a period of time. For instance, one could characterize the average duration of communications during the said period, the average number of conversations, etc. These data variables can be extended by considering specific groupings of the data. For instance, one could characterize the average duration of conversations grouped by the starting user (started vs replied). Also, one could consider the variability of a series of values, for instance the variance of duration for communications started by the user. Other metrics of regularity and dispersion, such as entropy, can be utilized to generate additional variables to represent the communication patterns of the user. Also, variations of these variables to the different modalities of communication can be trivially derived from the given examples. For instance, duration of voice communication events can be extended to the text modality by considering the length of the communications in multiple forms (number of characters, number of words, etc.)
Mobility patterns, including data variables related to the mobility patterns of the user: distance traveled in the said period, frequency of travelling events, regularity of the trips in terms of the spatial (geographic location visited) and the temporal (time of the day, day of the week, etc.) dimensions, patterns of stationary behavior (which can be used to infer working status, for instance), velocity to travel between origin and destination.
In this group of data variables are considered all mobility events, not necessarily long trips but daily mobility patterns, that complement the rest of the dimensions described to profile the behavior and personality of the user in depth.
Location patterns, including, but not limited to, data variables related to the geographical locations visited by the user. Geographical locations can be understood at different level of granularity and semantics. For instance, GPS coordinates provide an accurate view of the location but require from reverse geocoding mechanisms to associate them to a semantically relevant entity (country, city, street, number, name of business, etc.).
In the context of present invention, both raw coordinates and high level location entities can be utilized to profile the user. Some examples of variables in this group include: home and work locations, regularity of location in the said period (can be used to track home/work address changes and ownership of multiple households), location at pre-defined times of interest (evenings of weekdays, etc.).
Moreover, this group of data variables can increase their relevance by considering external information about the locations visited by the user, such as socio-demographic profile of the locations, which can be extracted from governmental reports of the user's country of residence.
Social Network metrics, including data variables related to the group of people that the user interacts with, for instance by means of communication events. In this group, variables such as number of people that interacted with the user during said period, distribution of such interactions in time using metrics of dispersion (daily variance, entropy, etc.).
In this group of data variables it is especially interesting to consider the grouping by interactions according to who started the communication: the user or a third party, as the characteristics of the social network in both cases can be very different. Additionally, bidirectional (or corresponded) social interactions have the potential of revealing interesting characteristics of the social network of the user, as they pinpoint relationships with stronger ties.
Other, including top-up and other CRM information of the user.

The different types of data variables described above can characterize the user in a similar way that other alternative methods try to accomplish by asking him/her to fill lengthy questionnaires. Such methods, based on inferring psychographic profiles, present a number of inconveniences that decrease their performance and applicability: they require users to spend long periods of time filling up the questionnaires, and they rely on the accuracy of the self-reported and subjective answers to those questionnaires. The proposed method is able to infer the user psychographics profile by observing the daily behavior of the user in their natural environment, which does not suffer from the two drawbacks previously described.

Another important advantage of the proposed method is its ability to implicitly account for some demographic data variable of the user. Differences in cultural background, gender or age have an observable impact on the behavior of users, even without knowing these parameters a priori. By considering the proposed multi-factorial representation model, some of these parameters are mapped into the many data variables that constitute the representation of the user, thus providing this information in an indirect manner. Given that regulatory bodies often forbid the explicit use of certain demographic parameters for creditworthiness scoring, this method offers a way to indirectly leverage these demographic parameters in the model without including them explicitly and while preserving the user's privacy.

The representation proposed in this invention differs from previous inventions in that it does not pursue an ad-hoc prediction objective, but attempts to profile users at a psychological and behavioral level to statistically infer their creditworthiness. For instance, in previous work the analysis of the user's social network is proposed to detect bust out fraud in the credit card business. This type of fraud is normally performed in the context of a team and often involves identity theft. This previous works analyses the user's social network to look for patterns consistent with these characteristics. Conversely, the social network analysis proposed in this invention gathers information of the user's social network to identify the characteristics that are correlated with creditworthiness.

Moreover, this invention differs from previous works in the way it analyzes communication patterns. In previous works related to creditworthiness assessment the analysis of communications may involve monitoring online activity (for instance in social networks, such as Facebook™) to detect evidence of dishonest behavior or any other activity that could be correlated with high probability of credit default. For instance, the user would need to fill out a credit application form stating some facts about his current employment, while the user may write online that is currently unemployed. Such incongruences can be included in the credit scoring model to lower the user's credit score. In contrast, the analysis of communications proposed in this invention gathers information about the user's patterns of communication to identify factors that are directly correlated with creditworthiness.

An important advantage of the representation proposed in this invention is that it can be implemented to its full extension and with a wide spectrum of population coverage worldwide using the data passively collected by mobile telecommunication providers (Telco's). This is facilitated by the wide adoption of mobile telephony at world level, including developing countries. Meaning that a very high level of the world population will have access to the creditworthiness score proposed in this invention (when compared to standard financial history-based scores), and with little or no effort given that the information is passively collected from their daily use of mobile phone.

### Telco as Information Collector

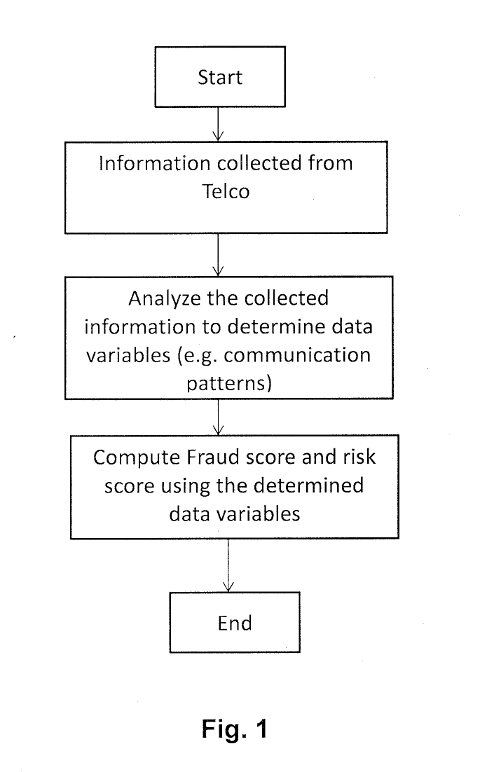

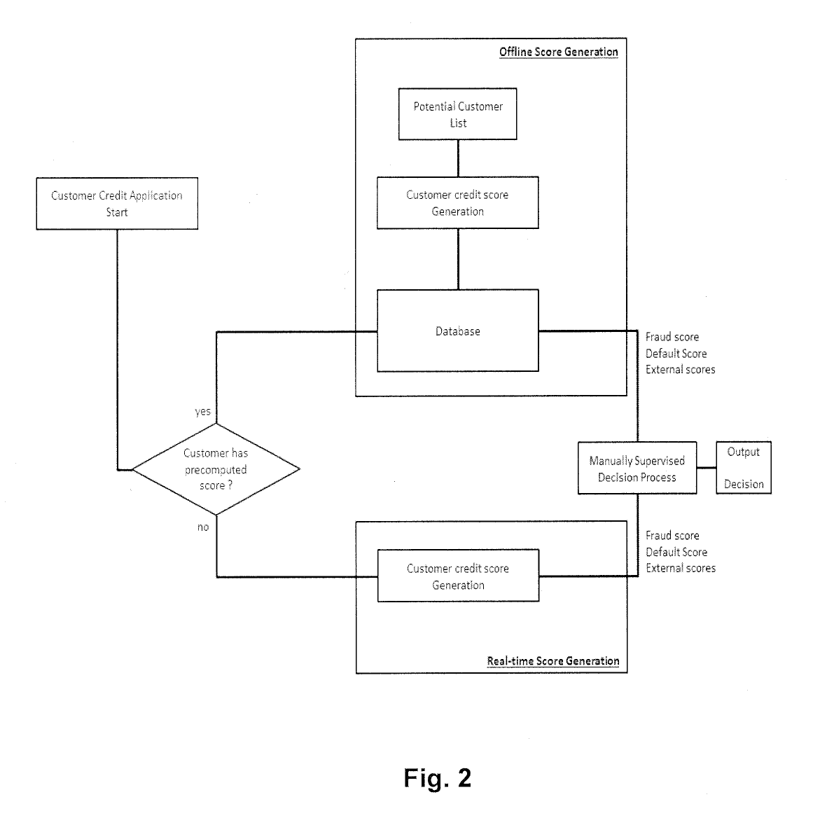

FIG. 1 illustrates an embodiment of the overall method steps executed by at least one processor of a computing system for assessing the credit worthiness of a user. The proposed method is implemented by analyzing the information passively collected by mobile telecommunication providers, preferably including Call Detail Records (CDR), for example calls performed by a user (either started and/or received). Then data variables are determined by analyzing the collected information, during a specific timeframe P of the user activity, most typically a number N of months. As a result, all communication that do not occur during the defined period of analysis are first filtered out from a database of the computing system so the final feature values reflect the different dimensions of activity only for the specific timeframe. It is preferred, but not limited to, that said period is greater or equal than one week, as to reflect a meaningful and significant number of events. Once the data variables are determined, a default risk score and a fraud risk score of the user are computed.

Apart from calls, the CDR may also include text messages (SMS) sent/received by the user. Moreover, the collected data may also include network traces/events, which include periodic pings by the communication network to the computing devices of the user, hand-over events, etc.

The communications pattern of the proposed method can be generated from the calls of the CDR collected (and also by the text messages events of the CDR and/or by network events), including data variables computed in said specific timeframe P, such as number of calls, number of text messages, duration of calls, time between consecutive calls, time between consecutive text messages, time between consecutive communication events, etc. This set of data variables can be extended by considering subsets of the communication events that enrich the psychometric profile of the user. For instance, one may choose to consider reciprocated communication events, that is, communication events that are responded within a specific timeframe (for instance, a text message sent as a response to previous message within thirty minutes of the first). This is an interesting case, as it targets communication events that involved a bidirectional interaction, which can be considered a proxy of higher importance. In this case, present invention would add to the user representation the following data variables following the previous example: number of reciprocated calls, number of reciprocated text messages, time between consecutive reciprocated calls, time between consecutive reciprocated text messages. Additionally, the proposed method considers including variables that compare the overall data variables with the ones extracted for this subset, for instance fraction of reciprocated calls with respect to the total number of calls, fraction of reciprocated text messages with respect to the total number of text messages. This extension scheme can be applied for any different subset considered of the communications log.

The social network metric of the proposed method can be generated by analyzing the list of people contacted by the user by means of the communication network. This analysis will allow extracting data variables for said specific timeframe P such as: communication degree centrality (number of unique communication contacts), clustering coefficient of the communication network (which measures how connected are the contacts of the user between themselves), as well as other relevance centrality measures (closeness centrality, betweenness centrality, eigenvector centrality, etc.). All this data variables are extracted from the social network graph, which has users as nodes, and edges connect all pairs of users that have interacted through the communication network. Depending on the type of interaction, call or text message, different graphs can be derived. For instance, one could consider the graph of calls, or the graph of all communication events. The data variables described can be extracted from as many communication graphs as desired and included in the HDD model of the user.

The mobility pattern of the proposed method can be generated by approximating the location of the user by the position of the BST used by the said user when interacting with the communication network. Using the position of antennas, the following data variables related to mobility in the said specific time frame P can be extracted: radius of gyration (radius of the smallest circle that contains all the locations a user has visited), distance travelled (sum of distances between consecutive locations), popular locations (fraction of the recurrent locations visited to account for 66% of communication events performed by the user).

The location pattern of the proposed method can be generated by approximating the location of the user by the position of the BST used by the said user when interacting with the communication network. Using the position of antennas, the following variables related to mobility in the specific time frame P can be extracted: home location (inferred from the most common location on weekdays night), work location (inferred from the most common location on weekdays office hours), number of different home/work locations, location at pre-defined times of interest (evenings of weekdays, etc.). To increase the information conveyed by this data variables and reduce the sparseness of the proposed method representation, a prefer embodiment will consider to merge locations with external data sources of information about them, such as socio-demographic profile of the locations, which can be extracted from governmental reports of the user's country of residence.

### Groupings of Data

The data variables described to build the proposed method from Telco data can be generated at different granularities of time. The concept of the period of analysis, P, has been already introduced which frames the temporal range of the collected information used to compute the data variables. Given the intrinsic variability of human behavior in time, an embodiment of this invention considers a finer grain view of the data variables based on a daily window. One can further subdivide the temporal dimension to finer splits of specific interest. For instance, consider weekdays (Monday to Friday) vs weekend (Saturday and Sunday); and office hours vs leisure hours (where office hours can be adapted to the geographic area considered, but most typically comprise the interval between 09:00 AM and 06:00 PM). This subdivision leads to four disjoint time windows, leading to a new set of data variables that consider only the collected information that fulfill the time constraints of each of these windows.

In addition, communication events are organically directional: the user could be either the starter of the event or the receiver. One can also choose to group events by their directionality to produce two sets of variables: for incoming events (received calls and SMSs) and for outgoing events (calls and SMS originated by the user).

Both of these groupings schemes can be applied concurrently to extend the set of data variables in the proposed method. For the purpose of illustration the data variable representing the number of calls would lead to eight new data variables: number of incoming/outgoing calls on weekdays/weekend at office/leisure hours. It should be obvious to anyone versed in the art that the proposed scheme can be extended to all the data variables described.

### Aggregations

Most of the data variables described to build the proposed method from Telco information consider aggregating the collected information, possibly within the frame of a specific timeframe and with a specific directionality. As an example, consider the following variable described above: number of calls. Calls can be aggregated at the period level (one month, for instance); one can also consider an intermediate aggregation on a daily basis (for instance, daily outgoing calls on weekdays at working hours). This latter option leads to a series of values, the user count of daily calls within the grouping criteria established (weekdays, working hours). This series can be represented by its average value, either the mean or the median depending on the characteristics of the underlying distribution.

The aforementioned series of values can be further represented by a metric of statistical dispersion, which provides a measurement of the regularity of the variable along time. A commonly used measure of dispersion is the variance (or alternatively the standard deviation), which considers the difference of the values from the mean.

The regularity of the variables presented within the multiple facets of the proposed method give important insights about the behavior of the user, with high likelihood to correlate to personality traits relevant for the creditworthiness profile. To the end of enriching the representation of this variability, one can extend the measures of dispersion used to characterize the data variables. For instance, one can use metrics from the Information Theory field to measure the entropy (or predictability) of the user's behavior. Entropy can be computed using the Shannon's definition:

H(X)=−Σ_{xεV}p(X=x)log(p(X=x))

where X is a discrete random variable taking values from the set V, and P(X) is its probability mass function. Using this definition several measures of entropy for the different factors can be defined, for example:
Call Time Entropy: with V each of the time windows defined (weekday at working hours, etc.), X is a discrete random variable taking values from the set V, and P(X) is its probability mass function (probability of calling in each of the windows).
SMS Time Entropy: analogous to Call Time Entropy, using text message events.
Communications Time Entropy: analogous to Call Time Entropy, using all communication events.
Communication entropy: where V is the list of contacts, and P(X) is defined by computing the fraction of calls between the considered customer and each contact with respect to all the calls of the user.
BTS entropy: where V is the list of BTSs, and P(X) is the fraction of communication events made from each BTS.

In addition to these measures of dispersion, one can further characterize the regularity of data variables by means of comparing values between the different partitions or groupings considered. For instance, one can extend the degree centrality variable by considering how the user's degree varies between the different time windows considered: weekday vs weekend, working hours vs leisure hours, as well as any other combination.

### Telco Proprietary Information

The proposed method can be enriched by also considering the collected information including data directly related to the financial behavior of the users, such as their use of top-ups in pre-paid lines about users (normally stored in the Customer Relationship Management database (CRM)).

Top-ups performed by the user can be considered as additional information and one can extract data variables from this additional information similarly to CDRs: number of top-ups, monetary amount of top-ups, time between top-ups, number of top-ups with economic value above/below a specific threshold, etc. One could also apply grouping criteria (for instance, time windows) and aggregations to further extend the number of data variables and enrich the proposed method.

Telco's have access to additional information about the user that can also be used to complement the proposed method such as:
Line type, indicating the type of phone line owned by the user (prepaid, postpaid)
Line status, active or not.
Line quantity, number of lines activated under the same user id.
Phone brand, brand of the user's phone.
Phone operating system, operating system of a user's phone.
Type of device, indicating if the user's device is a smartphone.
Months since activation, number of months elapsed since the phone line was activated.

### Model Building

The proposed method can be used to train supervised machine learning models that learn to predict the probability of credit default for users as a function of their HDD profile, which can be based on their use of the communication network. The method is trained using past information from previous users for which it is known if they defaulted or not (ground truth).

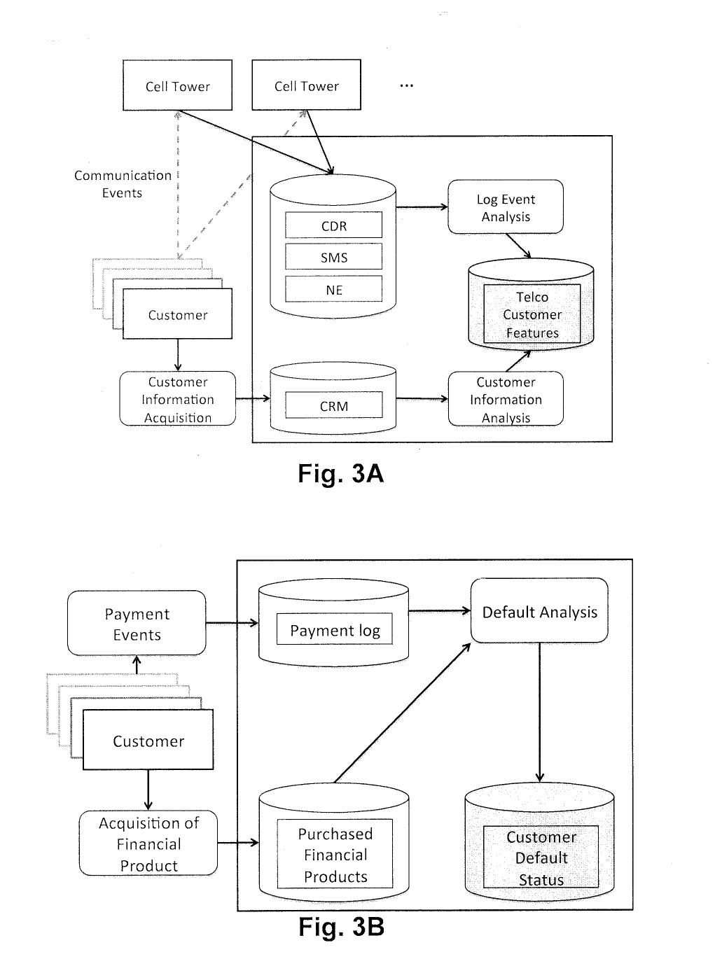

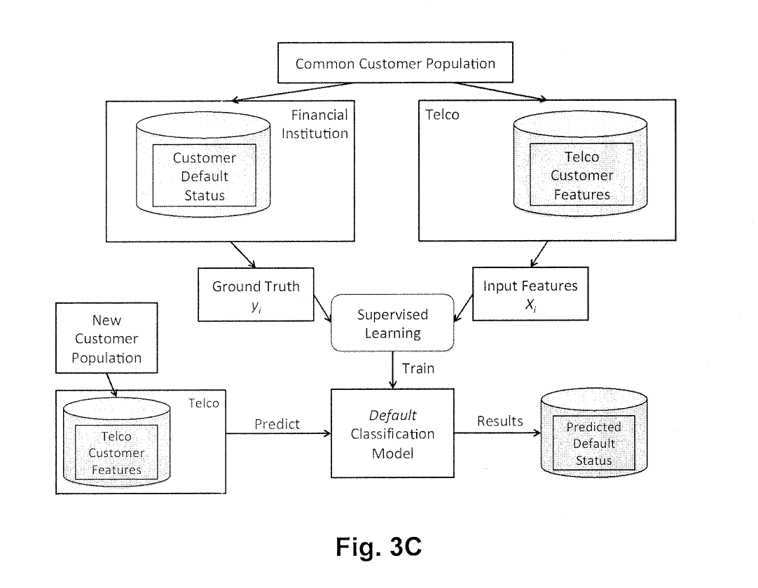

In one embodiment of this invention, the strategy to predict a default probability for the user using Telco data will follow the procedure depicted in FIGS. 3A, 3B and 3C, and outlined in the following enumeration:

1) Customers (users) of the Telco use their computing devices to communicate with other people or with the Internet via Cell Towers (BTSs) (as seen in FIG. 3A).
2) Internet access and CDR, such as calls and SMS messages, are collected by the Telco for billing purposes in the following databases: CDR, SMS and NE. In addition to the information collection, the Telco keeps additional data about its customers in the CRM, which includes demographic information, types of contract, number of lines, average bill amount, etc.
3) The collected information is batched processed with a certain periodicity to extract meaningful features from them. These features represent each of the Telco customers in the feature space that will be used to learn the proposed risk assessment model.
4) The financial history of an overlapping population of customers of a financial product (mortgage, credit card, loan, etc.) is analyzed to detect those that defaulted (see FIG. 3B). Note that the definition of “default” could vary for each different product, and could have multiple variations depending on the objective function. A common default criterion is the following: customers that have not fulfilled an installment of their total debt after T days from the deadline. T is normally equal to 90 days.
5) Consider the overlapping population of customers of the Telco and the financial product. Using Telco features as the customer's representation, and financial status (default or not) as the dependent variable to predict, supervised classification methods can be used to build a predictive model of the financial status (default or not). In general, supervised classification methods are able to predict the probability of a customer belonging to the risky/non-risky class. (FIG. 3C)
6) This model can be ideally used in the same context (same financial product and objective function) to predict the risk level of potentially new customers of the financial product which are already customers of the Telco. (FIG. 3C)

All the data analytics and modeling can be done in an anonymous manner by encrypting the identifiable information in the data, such that no identity is revealed.

### Modeling Problem

In one embodiment of this invention, the creditworthiness modeling approach is defined to follow a supervised learning paradigm. The general form of supervised learning methods is as follows. Given a set of M training samples {(X₁, y₁) . . . (X_{M}, y_{M})}, with Xᵢ in R^{N} (an N-Dimensional vector of real numbers) and yᵢ in {0,1} (for binary classification setting), the problem is to find a function ƒ: R^{N}→[0,1] that minimizes the classification error, for a specific error metric. This function is learnt using the observed pairs (Xᵢ, yᵢ), that is, the population of customers of the telco, Xᵢ which had an observable financial history, yᵢ.

In the problem setting considered by present invention, the vectors X correspond to the representation of each customer as a function of their interaction with the communication network of the telco (e.g. CDR) as well as additional information collected by the telco (e.g. CRM). Techniques such as feature scaling, feature selection or model parameter tuning can be used to improve the performance of the resulting predictive models.

The problem of finding this particular function ƒ has been widely studied in the literature and most classification approaches that fit this particular formulation of supervised learning could be used in this problem setting. The following enumeration gives some examples of valid supervised learning algorithms: logistic regression (and other regularized generalized linear models), support vector machines, random forests, gradient tree boosting, naïve Bayes, Adaboost, Neural networks, etc.

Once the function ƒ is determined, it can be used to infer the risk group of Telco customers for which the information of the financial institution is either non-existent or not suitable for providing an accurate risk assessment. It can also be used as a complementary risk metric, to be used in conjunction with other credit scores derived from Credit Bureaus or from internal processes of the financial institutions (based on the previous history of the customers).

### Modeling and Decision Making Alternatives

In one embodiment of this invention, one can take advantage of the use of supervised learning methods that predict not just labels for any new data point X′, but the actual probability p(y′=1|X′) of a customer defaulting the specific financial product. Having a continuous probability instead of a binary label as the output of the classifier allows using different decision strategies with respect to the final action to take for a given user.

For instance, the values p(y′=1|X′) can be used in the following ways:
Given a threshold tin the range [0,1], assign a risk label using

$$C ( {y}^{′} ) = \{ \begin{matrix}1 , & if p ( {y}^{′} = 1 \vert {X}^{′} ) > t \\ 0 , & otherwise\end{matrix}$$

where a common value is t=0.5
Rank users in increasing value of p(y′=1|X′) and label the top K users as y′=0, and the remaining as y′=1. The value of K can be determined using different criteria. The simplest approach would assign K=C, given a fixed number C of financial products to available to sell, i.e. sell them to the least risky clients.

### Modeling Multiple Risk Profiles

The supervised modeling strategy described above generate models that are dependent on the particularities of the data sources used, and may experience significant variations between different geographic locations, target populations, or financial services considered. This invention considers a framework to model each problem userly. Solving the multiplicity of problems would require generating different models adapted to each scenario, each of them trained using input data relevant to them. It is possible to use models across different scenarios if there is not enough data to create an ad-hoc model for it.

In particular, the proposed method considers the multiple ways in which risk may be defined, depending on the financial institution or financial product/service considered. The following examples illustrate this multiplicity of definitions:
Number of days in arrears: the positive samples are parameterized by the minimum number of days in arrears, T, to consider a customer in default. For instance, if T=30 days, then customers with a pending payment 30 or more days will be considered as positive default samples.
Maturity period: a parameter M can be used to characterize the time of observation since the customer activated the financial product (e.g. credit card). The observation of default (as defined by the parameter T) is performed exactly after this maturity period M. A short maturity period, e.g. M=3 months, can be used to consider a fraud scenario, building a model that tries to predict especially risky customers that will default as soon as they activate their financial product. With M>6 months, we have a more classic definition of credit default, where M will depend mainly on the type of product and the lender institution.

In addition to different metrics of default, financial institutions may be also interested in other metrics of credit performance, such as:
Customers that never activate the financial product after it has been provided (e.g. issued in the case of a credit card)
Customers that spend less than E economic units. An interesting specific case of this scenario is customers that do not spend any money using the financial product (E=0), especially relevant in the case of credit cards.

Each of the described scenarios, as well as many other related, can be modeled using the framework proposed in this invention, although the ground truth from the financial institutions used to train the supervised models need to be different as to reflect the specific positive/negative cases provided the different conditions described.

The proposed invention may be implemented in hardware, software, firmware, or any combination thereof. If implemented in software, the functions may be stored on or encoded as one or more instructions or code on a computer-readable medium.

Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal.

As used herein, computer program products comprising computer-readable media including all forms of computer-readable medium except, to the extent that such media is deemed to be non-statutory, transitory propagating signals.

The scope of the present invention is defined in the following set of claims.

1. A computer-implemented method for assessing the credit worthiness of a user, the method comprising:
collecting, by a data collector, information about communications conducted by users' of a communication network, the collected information at least comprising Call Detail Records including calls;
analyzing, by a computing system, during a specific time frame, the collected information regarding a particular user including communications' started by the particular user and/or communications' received by the user, and determining, data variables from the analyzed information, the data variables including at least communication patterns; and
computing, by the computing system, both a default risk score and a fraud risk score of the particular user by using the determined data variables.

2. The method of claim 1, wherein at least one parameter including a maturity period to determine whether the computed risk score is a default risk score or a fraud risk score is further used, said maturity period using a given threshold characterizing a time of observation since a financial product is activated by the particular user.

3. The method of claim 1, wherein the data variables further include at least one of location patterns, mobility patterns and social network metrics.

4. The method of claim 1, further comprising displaying the computed default risk score and the fraud risk score in a single two dimensional graph, and the method further comprising assessing an overall risk parameter of the particular user.

5. The method of claim 1, further comprising analyzing several financial products for the particular user by using the computed default risk score and the fraud risk score, the several financial products at least including a credit card credit, a personal loan, a telephone and communication contract, and/or a microcredit.

6. The method of claim 1, wherein the collected data further comprises text messages and/or network traces.

7. The method of claim 1, wherein the communication patterns includes determining: a number and duration of the communications, and/or a type of the communications including voice and/or text, and/or a ratio of the communications actively started by the users versus replied, and/or a ratio of time spent talking by the particular user versus time spent listening and/or a number of participants in the communication.

8. The method of claim 3, wherein:
the mobility patterns includes determining: a distance traveled by the particular user during said specific time frame, and/or a frequency of travelling events, and/or a regularity of the trips in terms of a spatial and a temporal dimension, and/or a pattern of stationary behavior of the particular user, and/or a velocity to travel between an origin and a destination during a communication;
the location patterns includes determining: a home and/or work location of the particular user, and/or a value representing the regularity of location in said specific time frame, and/or a location at a pre-define time of interest; and/or
the social network metrics includes determining: a number of people with which the particular user has communicated or has received a communication during said specific time frame, and/or a distribution of the communications in time using metrics of dispersion including a daily variance and/or an entropy variable.

9. The method of claim 1, wherein the specific time frame is greater or equal than one week.

10. The method of claim 1, wherein the specific time frame is at least one month.

11. The method of claim 1, wherein the information being collected on a daily basis.

12. The method of claim 11, wherein the information being collected during a time period comprised between 9 am to 6 pm.

13. The method of claim 1, wherein the information being collected only on weekdays or on the weekends.

14. The method of claim 1, wherein said given threshold of the maturity period is three months.

15. The method of claim 1, wherein said at least one parameter further including a number of days in arrears to consider the particular user in default.

16. The method of claim 1, wherein the information collected by the data collector top-ups or online payments performed in their phone lines, and the method further comprises determining data variables about a financial pattern of the particular user, said financial pattern including determining: a number of top-ups performed, and/or monetary amount of the top-ups, and/or time between top-ups, and/or a number of top-ups with economic value above/below a specific threshold.

17. A system for assessing the credit worthiness of a user, comprising:
a data collector that collects information about communications conducted by users' of a communication network, the collected information at least comprising Call Detail Records including calls; and
a computing system with one or more processors that:
analyzes, during a specific time frame, the collected information regarding a particular user including communications' started by the particular user and/or communications' received by the user;
determines data variables from the analyzed information, said data variables including at least communication patterns; and
computes both a default risk score and a fraud risk score of the user by using the determined data variables.

18. The system of claim 17, wherein the data collector comprises or has access to a memory or database to store the collected information.

19. A non-transitory computer-readable medium comprising computer-readable instructions recorded thereon for:
accessing or receiving, by a computing system, an information about communications conducted by users' of a communication network, said information being collected by a data collector and at least comprising Call Detail Records including calls;
analyzing, by the computing system, during a specific time frame, a collected information concerning a particular user including communications' started by the particular user and/or communications' received by the user;
determining, by the computing system, data variables from the analyzed information, said data variables including at least communication patterns; and
computing, by the computing system, both a default risk score and a fraud risk score of the user by using the determined data variables.
